(19) United States
(12) Patent Application Publication
(10) Pub. No.: US 2023/0386342 A1
(43) Pub. Date: Nov. 30, 2023

(54) COMPUTING PLATFORM FOR VEHICLE DATA COLLECTION AND ANALYSIS

(71) Applicant: Volvo Car Corporation, Gothenburg (SE)

(72) Inventors: Krister Johansson, Horred (SE); Anders Börjesson, Bralanda (SE)

(21) Appl. No.: 17/664,983

(22) Filed: May 25, 2022

(51) Int. Cl. G08G 1/00; G07C 5/00; G07C 5/08

(52) U.S. Cl. CPC G08G 1/20; G07C 5/008; G07C 5/0841

(57) ABSTRACT

Systems, devices, computer-implemented methods, and/or computer program products that can facilitate a flexible compute platform for on-board data collection and analysis of vehicle data are addressed. In one example, a system can comprise a processor that executes computer executable components stored in memory, the computer-executable components comprising: an application programming interface component operably coupled to a data service network of a vehicle; and a measurement and processing assignments component that executes a plurality of measurement and processing assignments comprising binary executable algorithms that collect and analyze the vehicle data, such that data collection and analysis of the vehicle data is not limited at least by types of the vehicle data that are collected and analyzed.

### BACKGROUND

One or more embodiments herein relate to computing devices, and more specifically, to systems, devices, computer-implemented methods, and/or computer program products that can facilitate a computing platform for vehicle data collection and analysis.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that can facilitate a computing platform for vehicle data collection and analysis are addressed.

An embodiment can comprise a system that provides a flexible compute platform for on-board data collection and analysis of vehicle data, the system comprising: a memory; and a processor, operably coupled to the memory, and that executes computer executable components stored in the memory, wherein the computer executable components comprise: an application programming interface component operably coupled to a data service network of a vehicle; and a measurement and processing assignments component that executes a plurality of measurement and processing assignments comprising binary executable algorithms that collect and analyze the vehicle data, such that data collection and analysis of the vehicle data is not limited at least by types of the vehicle data that are collected and analyzed.

Another embodiment can comprise a computer-implemented method, comprising: executing, by a system operably coupled to a processor, a plurality of measurement and processing assignments comprising binary executable algorithms that collect and analyze vehicle data, such that data collection and analysis of the vehicle data is not limited at least by types of the vehicle data that are collected and analyzed.

Another embodiment can comprise a computer program product that facilitates a flexible compute platform for on-board data collection and analysis of vehicle data. The computer program product comprises a non-transitory computer readable medium having program instructions embodied therewith, the program instructions executable by a processor to cause the processor to: execute, by the processor, a plurality of measurement and processing assignments comprising binary executable algorithms that collect and analyze the vehicle data, such that data collection and analysis of the vehicle data is not limited at least by types of the vehicle data that are collected and analyzed.

### DESCRIPTION OF THE DRAWINGS

One or more exemplary embodiments are described below in the Detailed Description section with reference to the following drawings.

FIG. 1 illustrates a block diagram of an example, non-limiting system that facilitates a computing platform for vehicle data collection and analysis in accordance with one or more embodiments described herein.

FIG. 2 illustrates a block diagram of an example, non-limiting computing environment that facilitates a computing platform for vehicle data collection and analysis in accordance with one or more embodiments described herein.

FIG. 3 illustrates an example, non-limiting computer-implemented method that facilitates a computing platform for vehicle data collection and analyses in accordance with one or more embodiments described herein.

FIG. 4 illustrates a block diagram of an example, non-limiting operating environment in which one or more embodiments described herein can be facilitated.

FIG. 5 illustrates a block diagram of another example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

The principal challenge addressed by the invention is that it can provide a flexible computing platform for on-board data collection and analysis of vehicle data, via binary executable algorithms or scripts, through a cloud-based orchestration of measurement and processing assignments. Development of a car can require large amounts of data for exploring and testing possible technical designs, for simulating and verifying expected behavior of the systems, for validating the product to be released or for finding problem root causes in released products. By facilitating on-board data collection and analysis of vehicle data, the invention discussed herein can further provide for seamless integration of data collection and analysis tasks that can enhance rapid prototyping and development of vehicles. The results of the on-board analysis can be provided to other vehicles via artificial intelligence based collaborative learning, to further enhance the development of vehicles. The invention can also provide flexibility of data collection and analysis, such that the data collection and analysis tasks can be unrestricted by the types of vehicle data that can be collected and analyzed and by the types of triggers that can be used to determine when the data collection can initiate. The measurement and processing assignments that can facilitate collection and analysis of the vehicle data can be user controlled, wherein a human entity, such as a creator of the measurement and processing assignments, can control execution of the measurement and processing assignments, thereby extending the flexibility aspect of the invention. The execution of the measurement and processing assignments can further be controlled in accordance with a defined schedule or in accordance with instructions from a computerized feedback.

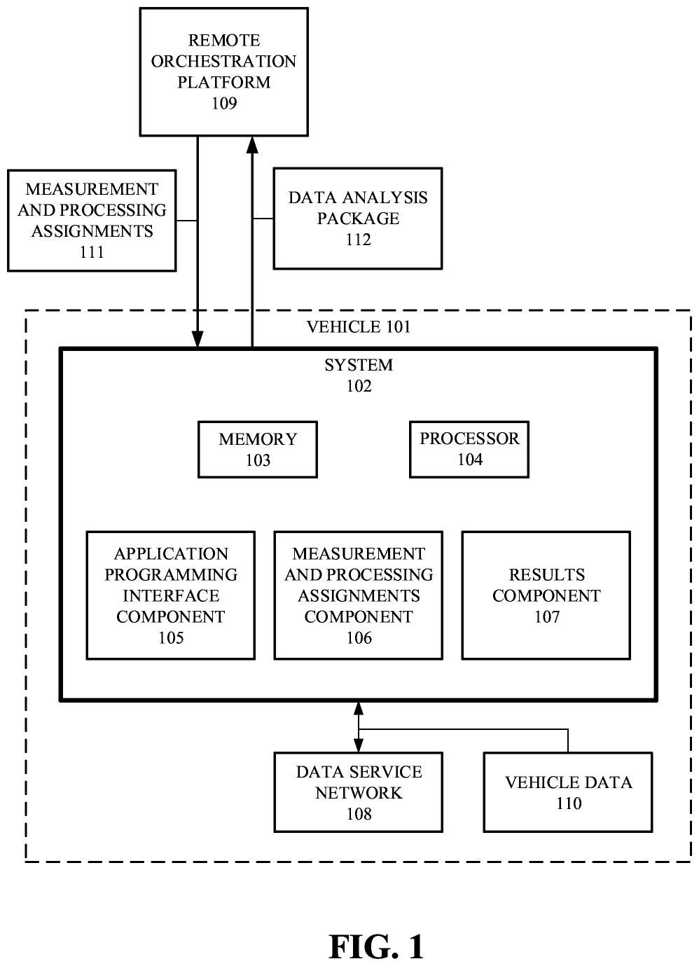

FIG. 1 illustrates a block diagram of an example, non-limiting system that facilitates a computing platform for vehicle data collection and analysis in accordance with one or more embodiments described herein. FIG. 1 can comprise vehicle 101, system 102, memory 103, processor 104, application programming interface component 105, measurement and processing assignments component 106, results component 107, data service network 108, and remote orchestration platform 109.

In one or more embodiments, vehicle 101 can comprise system 102 that can facilitate a flexible compute platform for on-board data collection and analyses of vehicle data 110. System 102 can further comprise application programming interface component 105 that can be operably coupled to data service network 108. Application programming interface component 105 can use on-board data service application programming interfaces (APIs) to reach data service network 108, wherein data service network 108 can comprise vehicle data 110. Vehicle data 110 can further comprise testing and simulation results, aerodynamic performance data, engine efficiency data, fuel consumption data, global positioning system (GPS) data, and other type of vehicle data that can assist engineers to validate performances of various systems in vehicle 101 and to detect root cause issues for development of vehicle 101.

Measurement and processing assignments component 106 can execute a plurality of measurement and processing assignments 111 comprising binary executable algorithms or scripts that can collect and analyze vehicle data 110, such that data collection and analysis of vehicle data 110 can be unrestricted by the types of vehicle data that can be collected and analyzed and by the types of triggers that can be used to determine when the data collection can initiate. Measurement and processing assignments 111 can collect vehicle data 110 from data service network 108 via application programming interface component 105. Measurement and processing assignments component 106 can concurrently execute multiple measurement and processing assignments 111 that can facilitate speedy collection and analysis of vehicle data 110 for various parameters. Thus, system 102 can facilitate seamless integration of data collection and analysis tasks, and the data analysis can be performed on-board vehicle 101. Results component 107 can generate data analysis package 112 based on the analysis of vehicle data 110, wherein data analysis package 112 can comprise results of the analysis of vehicle data 110.

Data analysis package 112 can be offloaded to remote orchestration platform 109, during or after collection and analysis of vehicle data 110, wherein data analysis package 112 can be shared with a fleet of vehicles such as vehicle 101 to promote collaborative learning amongst the fleet of vehicles via artificial intelligence. Data analysis package 112 can be offloaded to remote orchestration platform 109 in accordance with a defined schedule, in a flexible manner upon instructions from a human entity, such as a creator of the measurement and processing assignments, or in accordance with instructions from a computerized feedback.

Remote orchestration platform 109 can define measurement and processing assignments 111, and remote orchestration platform 109 can transmit measurement and processing assignments 111 to measurement and processing assignments component 106. Remote orchestration platform 109 can further define a management policy for measurement and processing assignments 111, wherein measurement and processing assignments component 106 can manage measurement and processing assignments 111 in a measurement and processing assignment execution environment, in accordance with the management policy. In one or more embodiments, the management policy can relate to vehicle fleet selection wherein individual vehicles or groups of vehicles can be addressed by the management policy. In one or more embodiments, the management policy can further address the physical dispatching of vehicles as well as privacy settings of individual vehicles and the respective vehicle users. Management of the measurement and processing assignments 111 by measurement and processing assignments component 106 can comprise installing, uninstalling, starting, or stopping execution of measurement and processing assignments 111.

Furthermore, the human entity can choose to install, uninstall, start, or stop measurement and processing assignments 111 as desired. Thus, data collection and analyses of vehicle data 110 can be flexible in terms of types of vehicle data 110 that can be collected and analyzed, as well as in terms of timing of execution of data collection and analysis tasks that can be performed by measurement and processing assignments component 106.

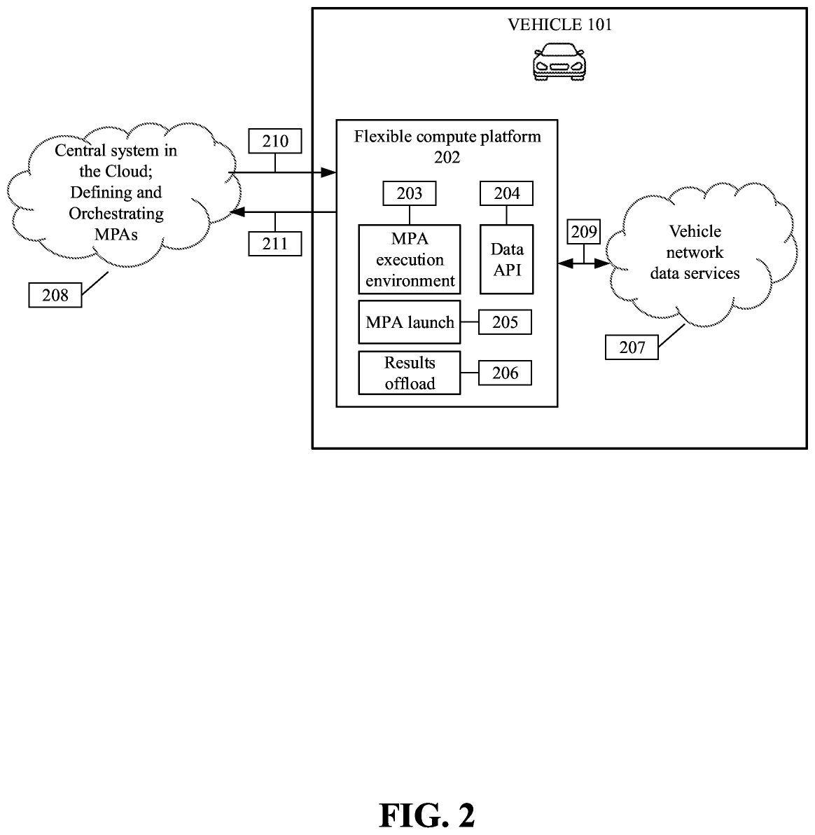

FIG. 2 illustrates a block diagram of an example, non-limiting computing environment that facilitates a computing platform for vehicle data collection and analysis in accordance with one or more embodiments described herein. FIG. 2 can comprise vehicle 101 of FIG. 1, and FIG. 2 can further comprise flexible compute platform 202. Thus, FIG. 2 can be understood with reference to FIG. 1. Additionally, it is to be appreciated that the term “MPA” in FIG. 2 can represent the term “measurement and processing” as used in the context of measurement and processing assignments, measurement and processing assignments component, and measurement and processing assignment execution environment. Repetitive description of like elements and/or processes employed in respective embodiments is omitted for sake of brevity.

In one or more embodiments, system 102 can provide flexible compute platform 202 for data collection and analyses of vehicle data 110 on-board vehicle 101, wherein flexible compute platform 202 can be a Linux based platform. At 207, data service network 108 can comprise vehicle data 110 on-board vehicle 101, wherein vehicle data 110 can comprise testing and simulation results, aerodynamic performance data, engine efficiency data, fuel consumption data, GPS data, and other type of vehicle data that can assist engineers with performance analysis of various systems of vehicle 101. At 209, flexible compute platform 202 can facilitate collection of vehicle data 110 from data service network 108, wherein at 204, flexible compute platform 202 can incorporate on-board data service APIs for collection of vehicle data 110.

At 205, flexible compute platform 202 can facilitate execution of measurement and processing assignments 111 comprising binary executable algorithms or scripts that can collect and analyze vehicle data 110 from data service network 108 via application programming interface component 105. As discussed in one or more embodiments herein, flexible compute platform 202 can provide seamless integration of data collection and analysis tasks by concurrently executing a plurality of measurement and processing assignments 111. The data collection and analysis tasks can be independent of the types of vehicle data that can be collected and analyzed and the types of triggers that can initiate or halt the data collection process. At 206, results of the analysis of vehicle data 110, generated by measurement and processing assignments component 106, can be compiled into data analysis package 112, wherein at 211, flexible compute platform 202 can facilitate offloading data analysis package 112 to remote orchestration platform 109, wherein remote orchestration platform 109 can comprise a cloud server.

At 208, remote orchestration platform 109 can define and orchestrate measurement and processing assignments 111, and remote orchestration platform 109 can further define management policies for measurement and processing assignments 111. At 210, remote orchestration platform 109 can transmit measurement and processing assignments 111 to flexible compute platform 202, wherein at 203, flexible compute platform 202 can facilitate a measurement and processing assignment execution environment wherein measurement and processing assignments component 106 can install, uninstall, start, or stop execution of measurement and processing assignments 111, in accordance with a management policy. In one or more embodiments, the management policy can relate to vehicle fleet selection wherein individual vehicles or groups of vehicles can be addressed by the management policy. In one or more embodiments, the management policy can further address the physical dispatching of vehicles as well as privacy settings of individual vehicles and the respective vehicle users. As discussed in one or more embodiments herein, data collection and analysis of vehicle data 110 can be flexible in terms of the types of vehicle data 110 that can be collected and analyzed, as well as in terms of the timing of execution of data collection and analysis tasks that can be performed by measurement and processing assignments component 106 via execution of measurement and processing assignments 111. Thus, flexible compute platform 202 can provide speedy and flexible collection and analysis of vehicle data 110 on-board vehicle 101.

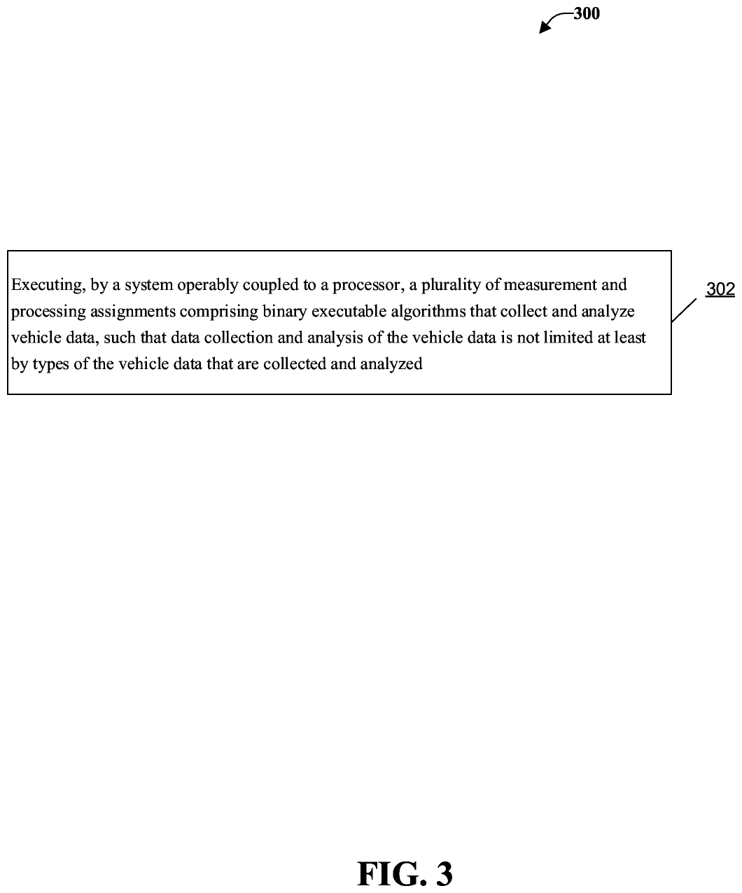

FIG. 3 illustrates an example, non-limiting computer-implemented method that facilitates a computing platform for vehicle data collection and analyses in accordance with one or more embodiments described herein. Repetitive description of like elements and/or processes employed in respective embodiments is omitted for sake of brevity.

In one or more embodiments, environment 300 can comprise at 302, a computer-implemented method that can facilitate executing, by a system operably coupled to a processor, a plurality of measurement and processing assignments comprising binary executable algorithms that collect and analyze vehicle data, such that data collection and analysis of the vehicle data is not limited at least by types of the vehicle data that are collected and analyzed.

One or more embodiments can be a system, a method, and/or a computer program product at any possible technical detail level of integration. The computer program product can include a computer readable storage medium (or media) having computer readable program instructions thereon for causing a processor to carry out one or more aspects of the present embodiments.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the entity's computer, partly on the entity's computer, as a stand-alone software package, partly on the entity's computer and partly on a remote computer or entirely on the remote computer or server. In the latter scenario, the remote computer can be connected to the entity's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

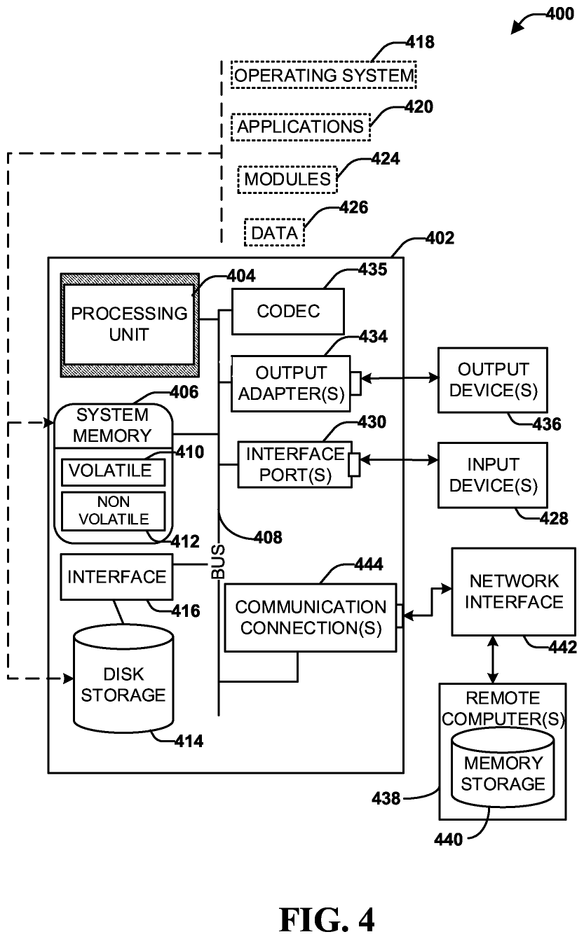

In connection with FIG. 4, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 4, an example environment 400 for implementing various aspects of the claimed subject matter includes a computer 402. The computer 402 includes a processing unit 404, a system memory 406, a codec 435, and a system bus 408. The system bus 408 couples system components including, but not limited to, the system memory 406 to the processing unit 404. The processing unit 404 can be any of various available processors. Dual microprocessors and other multiprocessor architectures also can be employed as the processing unit 404.

The system bus 408 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13224), and Small Computer Systems Interface (SCSI).

The system memory 406 includes volatile memory 410 and non-volatile memory 412, which can employ one or more of the disclosed memory architectures, in various embodiments. The basic input/output system (BIOS), containing the basic routines to transfer information between elements within the computer 402, such as during start-up, is stored in non-volatile memory 412. In addition, according to present innovations, codec 435 can include at least one of an encoder or decoder, wherein the at least one of an encoder or decoder can consist of hardware, software, or a combination of hardware and software. Although, codec 435 is depicted as a separate component, codec 435 can be contained within non-volatile memory 412. By way of illustration, and not limitation, non-volatile memory 412 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 412 can employ one or more of the disclosed memory devices, in at least some embodiments. Moreover, non-volatile memory 412 can be computer memory (e.g., physically integrated with computer 402 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 410 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 402 can also include removable/non-removable, volatile/non-volatile computer storage medium. FIG. 4 illustrates, for example, disk storage 414. Disk storage 414 includes, but is not limited to, devices like a magnetic disk drive, solid state disk (SSD), flash memory card, or memory stick. In addition, disk storage 414 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 414 to the system bus 408, a removable or non-removable interface is typically used, such as interface 416. It is appreciated that disk storage 414 can store information related to an entity. Such information might be stored at or provided to a server or to an application running on an entity device. In one embodiment, the entity can be notified (e.g., by way of output device(s) 436) of the types of information that are stored to disk storage 414 or transmitted to the server or application. The entity can be provided the opportunity to opt-in or opt-out of having such information collected or shared with the server or application (e.g. by way of input from input device(s) 428).

It is to be appreciated that FIG. 4 describes software that acts as an intermediary between entities and the basic computer resources described in the suitable operating environment 400. Such software includes an operating system 418. Operating system 418, which can be stored on disk storage 414, acts to control and allocate resources of the computer system 402. Applications 420 take advantage of the management of resources by operating system 418 through program modules 424, and program data 426, such as the boot/shutdown transaction table and the like, stored either in system memory 406 or on disk storage 414. It is to be appreciated that the claimed subject matter can be implemented with various operating systems or combinations of operating systems.

An entity enters commands or information into the computer 402 through input device(s) 428. Input devices 428 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 404 through the system bus 408 via interface port(s) 430. Interface port(s) 430 include, for example, a serial port, a parallel port, a game port, and a universal serial bus (USB). Output device(s) 436 use some of the same type of ports as input device(s) 428. Thus, for example, a USB port can be used to provide input to computer 402 and to output information from computer 402 to an output device 436. Output adapter 434 is provided to illustrate that there are some output devices 436 like monitors, speakers, and printers, among other output devices 436, which require special adapters. The output adapters 434 include, by way of illustration and not limitation, video and sound cards that provide a means of connection between the output device 436 and the system bus 408. It should be noted that other devices or systems of devices provide both input and output capabilities such as remote computer(s) 438.

Computer 402 can operate in a networked environment using logical connections to one or more remote computers, such as remote computer(s) 438. The remote computer(s) 438 can be a personal computer, a server, a router, a network PC, a workstation, a microprocessor based appliance, a peer device, a smart phone, a tablet, or other network node, and typically includes many of the elements described relative to computer 402. For purposes of brevity, only a memory storage device 440 is illustrated with remote computer(s) 438. Remote computer(s) 438 is logically connected to computer 402 through a network interface 442 and then connected via communication connection(s) 444. Network interface 442 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 444 refers to the hardware/software employed to connect the network interface 442 to the bus 408. While communication connection 444 is shown for illustrative clarity inside computer 402, it can also be external to computer 402. The hardware/software necessary for connection to the network interface 442 includes, for exemplary purposes only, internal and external technologies such as, modems including regular telephone grade modems, cable modems and DSL modems, ISDN adapters, and wired and wireless Ethernet cards, hubs, and routers.

The illustrated aspects of the disclosure may also be practiced in distributed computing environments where certain tasks are performed by remote processing devices that are linked through a communications network. In a distributed computing environment, program modules can be located in both local and remote memory storage devices.

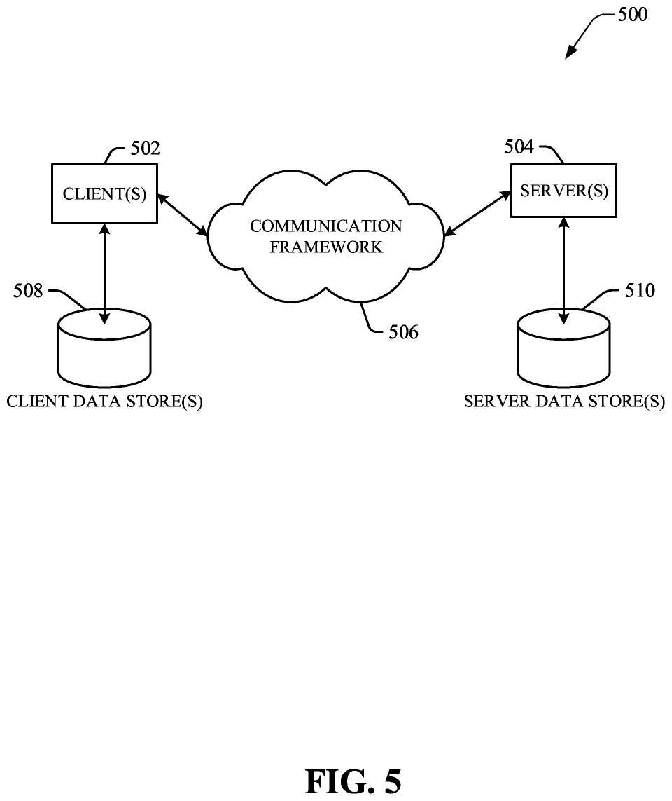

Referring to FIG. 5, there is illustrated a schematic block diagram of a computing environment 500 in accordance with this disclosure in which the subject systems (e.g., system 102, the like), methods and computer readable media can be deployed. The computing environment 500 includes one or more client(s) 502 (e.g., laptops, smart phones, PDAs, media players, computers, portable electronic devices, tablets, and the like). The client(s) 502 can be hardware and/or software (e.g., threads, processes, computing devices). The computing environment 500 also includes one or more server(s) 504. The server(s) 504 can also be hardware or hardware in combination with software (e.g., threads, processes, computing devices). The servers 504 can house threads to perform transformations by employing aspects of this disclosure, for example. In various embodiments, one or more components, devices, systems, or subsystems of system 102 can be deployed as hardware and/or software at a client 502 and/or as hardware and/or software deployed at a server 504. One possible communication between a client 502 and a server 504 can be in the form of a data packet transmitted between two or more computer processes wherein the data packet may include healthcare related data, training data, AI models, input data for the AI models and the like. The data packet can include a metadata, e.g., associated contextual information, for example. The computing environment 500 includes a communication framework 506 (e.g., a global communication network such as the Internet, or mobile network(s)) that can be employed to facilitate communications between the client(s) 502 and the server(s) 504.

Communications can be facilitated via a wired (including optical fiber) and/or wireless technology. The client(s) 502 include or are operatively connected to one or more client data store(s) 508 that can be employed to store information local to the client(s) 502 (e.g., associated contextual information). Similarly, the server(s) 504 are operatively include or are operatively connected to one or more server data store(s) 510 that can be employed to store information local to the servers 504 (e.g., application data).

In one embodiment, a client 502 can transfer an encoded file, in accordance with the disclosed subject matter, to server 504. Server 504 can store the file, decode the file, or transmit the file to another client 502. It is to be appreciated, that a client 502 can also transfer uncompressed file to a server 504 and server 504 can compress the file in accordance with the disclosed subject matter. Likewise, server 504 can encode video information and transmit the information via communication framework 506 to one or more clients 502.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “subsystem” “platform,” “layer,” “gateway,” “interface,” “service,” “application,” “device,” and the like, can refer to and/or can include one or more computer-related entities or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory. What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system that provides a flexible compute platform for on-board data collection and analysis of vehicle data, the system comprising:
a memory; and
a processor, operably coupled to the memory, and that executes computer executable components stored in the memory, wherein the computer executable components comprise:
an application programming interface component operably coupled to a data service network of a vehicle; and
a measurement and processing assignments component that executes a plurality of measurement and processing assignments comprising binary executable algorithms that collect and analyze the vehicle data, such that data collection and analysis of the vehicle data is not limited at least by types of the vehicle data that are collected and analyzed.

2. The system of claim 1, further comprising:
a remote orchestration platform, comprising a cloud server, that defines the plurality of measurement and processing assignments, wherein the remote orchestration platform further defines a management policy for the plurality of measurement and processing assignments.

3. The system of claim 2, wherein a measurement and processing assignments component manages the plurality of measurement and processing assignments in a measurement and processing assignment execution environment, in accordance with the management policy.

4. The system of claim 2, wherein the remote orchestration platform transmits the plurality of measurement and processing assignments to a measurement and processing assignments component.

5. The system of claim 1, further comprising:
a results component that generates a data analysis package based on the analysis of the vehicle data by the plurality of measurement and processing assignments.

6. The system of claim 5, wherein the results component offloads the data analysis package to a remote orchestration platform in accordance with at least a defined schedule, instructions from a human entity, or instructions from a computerized feedback.

7. The system of claim 1, wherein the memory is positioned in the vehicle, and wherein the plurality of measurement and processing assignments collect the vehicle data from the data service network via the application programming interface component.

8. The system of claim 1, wherein results of the analysis are shared across a fleet of vehicles by a remote orchestration platform via artificial intelligence based collaborative learning.

9. A computer-implemented method, comprising:
executing, by a system operably coupled to a processor, a plurality of measurement and processing assignments comprising binary executable algorithms that collect and analyze vehicle data, such that data collection and analysis of the vehicle data is not limited at least by types of the vehicle data that are collected and analyzed.

10. The computer-implemented method of claim 9, further comprising:
defining, by the system, the plurality of measurement and processing assignments, wherein a remote orchestration platform further defines a management policy for the plurality of measurement and processing assignments.

11. The computer-implemented method of claim 10, further comprising:
managing, by the system, the plurality of measurement and processing assignments in a measurement and processing assignment execution environment, in accordance with the management policy.

12. The computer-implemented method of claim 10, further comprising:
transmitting, by the system, the plurality of measurement and processing assignments to a measurement and processing assignments component.

13. The computer-implemented method of claim 9, further comprising:
generating, by the system, a data analysis package based on the analysis of the vehicle data by the plurality of measurement and processing assignments.

14. The computer-implemented method of claim 13, further comprising:
offloading, by the system, the data analysis package to a remote orchestration platform in accordance with at least a defined schedule, instructions from a human entity, or instructions from a computerized feedback.

15. The computer-implemented method of claim 9, further comprising:
collecting, by the system, the vehicle data from a data service network via an application programming interface component.

16. A computer program product that facilitates a flexible compute platform for on-board data collection and analysis of vehicle data, the computer program product comprising a non-transitory computer readable medium having program instructions embodied therewith, the program instructions executable by a processor to cause the processor to:
execute, by the processor, a plurality of measurement and processing assignments comprising binary executable algorithms that collect and analyze the vehicle data, such that data collection and analysis of the vehicle data is not limited at least by types of the vehicle data that are collected and analyzed.

17. The computer program product of claim 16, wherein the program instructions are further executable by the processor to cause the processor to:
define, by the processor, the plurality of measurement and processing assignments, wherein a remote orchestration platform further defines a management policy for the plurality of measurement and processing assignments.

18. The computer program product of claim 17, wherein the program instructions are further executable by the processor to cause the processor to:
manage, by the processor, the plurality of measurement and processing assignments in a measurement and processing assignment execution environment, in accordance with the management policy; and
transmit, by the processor, the plurality of measurement and processing assignments to a measurement and processing assignments component.

19. The computer program product of claim 16, wherein the program instructions are further executable by the processor to cause the processor to:
generate, by the processor, a data analysis package based on the analysis of the vehicle data by the plurality of measurement and processing assignments; and
offload, by the processor, the data analysis package to a remote orchestration platform in accordance with at least a defined schedule, instructions from a human entity, or instructions from a computerized feedback.

20. The computer program product of claim 16, wherein the program instructions are further executable by the processor to cause the processor to:
collect, by the processor, the vehicle data from a data service network via an application programming interface component.
